(19) United States
(12) Patent Application Publication
(10) Pub. No.: US 2018/0322330 A1
(43) Pub. Date: Nov. 8, 2018

(54) OBJECT RECOGNITION SYSTEM AND OBJECT RECOGNITION METHOD

(71) Applicant: VIVOTEK INC., New Taipei City (TW)

(72) Inventors: Cheng-Chieh Liu, New Taipei City (TW); Chih-Yen Lin, New Taipei City (TW)

(21) Appl. No.: 15/972,201

(22) Filed: May 6, 2018

(30) Foreign Application Priority Data
May 8, 2017 (TW) 106115104

(51) Int. Cl. G06K 9/00; G06T 7/20

(52) U.S. Cl. CPC G06K 9/00201; G06T 2207/10016; G06T 7/20

(57) ABSTRACT

An object recognition system includes an image capturing unit, a motion sensing module, a receiver and a processor. The image capturing unit captures an image sequence. The motion sensing module is disposed on a target object and includes a transmitter and a motion sensor. The motion sensor selectively drives the transmitter to transmit a plurality of wireless signals according to a plurality of motion states of the target object. The receiver receives the wireless signals. The processor analyzes the image sequence to obtain at least one first motion state curve corresponding to at least one object, generates a second motion state curve corresponding to the target object according to the wireless signals, and determines whether to recognize the object corresponding to the first motion state curve as the target object according to a correlation between the first motion state curve and the second motion state curve.

### BACKGROUND OF THE INVENTION

### 1. Field of the Invention

The invention relates to an object recognition system and an object recognition method and, more particularly, to an object recognition system and an object recognition method utilizing image analysis and motion sensor to recognize an object.

### 2. Description of the Prior Art

A system, which counts the number of persons or analyzes trajectory automatically by analyzing an image content, is now in widespread use and the related technology may be applied to perform queue management, path analytics or heatmap for a site. For a common store, to calculate accurate number of customers, it usually has to distinguish an employee and a customer from each other. A conventional solution is to dispose a transmitter on the employee, estimates a location of the employee by an indoor positioning manner or a proximity detection manner, and combines the location of the employee with analyzed image data, so as to count the number of employees and customers separately. The aforesaid manner usually needs to use a plurality of receivers and cooperates with trilateration principle, so as to estimate the location of the transmitter. However, since it needs to install lots of receivers, it will increase the cost of installation and maintenance. Furthermore, if the receivers get too close to each other, the accuracy will reduce. Furthermore, the aforesaid method depends highly on received signal strength indication (RSSI). When a signal in an environment is easy to be interfered, the signal strength is unstable, such that a distance or a position estimated by RSSI will be inaccurate.

### SUMMARY OF THE INVENTION

An objective of the invention is to provide an object recognition system and an object recognition method utilizing image analysis and motion sensor to recognize an object, so as to solve the aforesaid problems.

According to an embodiment of the invention, an object recognition system comprises an image capturing unit, a motion sensing module, a receiver and a processor. The image capturing unit is disposed in a site. The image capturing unit captures an image sequence of the site, wherein at least one object exists in the image sequence and the at least one object comprises a target object. The motion sensing module is disposed on the target object. The motion sensing module comprises a transmitter and a motion sensor, wherein the transmitter is electrically connected to the motion sensor. The motion sensor selectively drives the transmitter to transmit a plurality of wireless signals according to a plurality of motion states of the target object. The receiver is disposed in the site. The receiver receives the wireless signals . The processor is coupled to the image capturing unit and the receiver. The processor analyzes the image sequence to obtain at least one first motion state curve corresponding to the at least one object . The processor receives the wireless signals from the receiver and generates a second motion state curve corresponding to the target object according to the wireless signals. The processor compares the second motion state curve with the at least one first motion state curve and determines whether to recognize the at least one object corresponding to the at least one first motion state curve as the target object according to a correlation between the at least one first motion state curve and the second motion state curve.

According to another embodiment of the invention, an object recognition method comprises steps of an image capturing unit capturing an image sequence of a site, wherein at least one object exists in the image sequence, the at least one object comprises a target object, a motion sensing module is disposed on the target object, the motion sensing module comprises a transmitter and a motion sensor, and the transmitter is electrically connected to the motion sensor; the motion sensor selectively driving the transmitter to transmit a plurality of wireless signals according to a plurality of motion states of the target object; a receiver receiving the wireless signals; a processor analyzing the image sequence to obtain at least one first motion state curve corresponding to the at least one object; the processor receiving the wireless signals from the receiver and generating a second motion state curve corresponding to the target object according to the wireless signals; and the processor comparing the second motion state curve with the at least one first motion state curve and determining whether to recognize the at least one object corresponding to the at least one first motion state curve as the target object according to a correlation between the at least one first motion state curve and the second motion state curve.

As mentioned in the above, the invention utilizes image analysis and motion sensor to recognize the target object carrying the motion sensing module from a plurality of objects. In practical applications, the invention may integrate the image capturing unit, the receiver and the processor in a camera, dispose the camera at an appropriate position in the site, and dispose the motion sensing module on an employee (i.e. the target object). After recognizing the employee carrying the motion sensing module by the aforesaid method, the invention can filter out the employee, so as to calculate accurate number of customers. Accordingly, the invention can use one single receiver along with image analysis to distinguish an employee and a customer from each other, such that the invention can reduce the cost of installation and maintenance effectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an object recognition system according to an embodiment of the invention.

FIG. 2 is a flowchart illustrating an object recognition method according to an embodiment of the invention.

FIG. 3 is schematic diagram illustrating motion state curves.

FIG. 4 is a schematic diagram illustrating position coordinate and signal strength.

### DETAILED DESCRIPTION

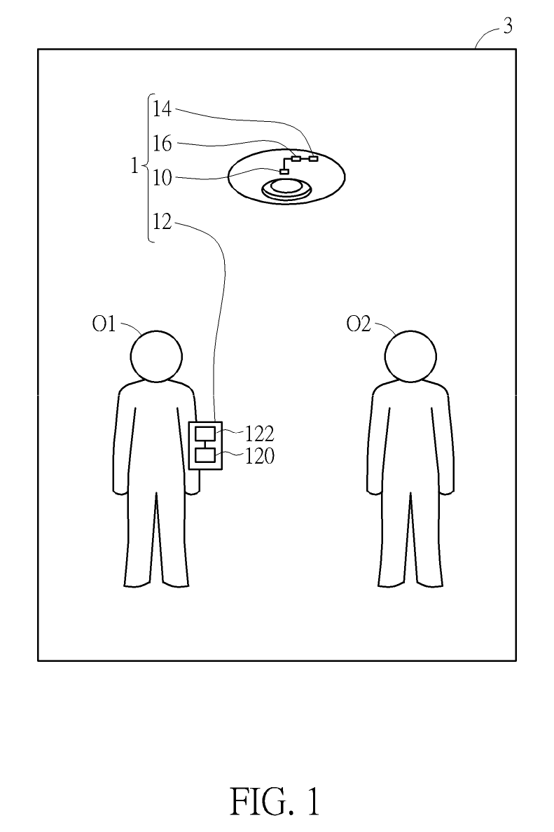

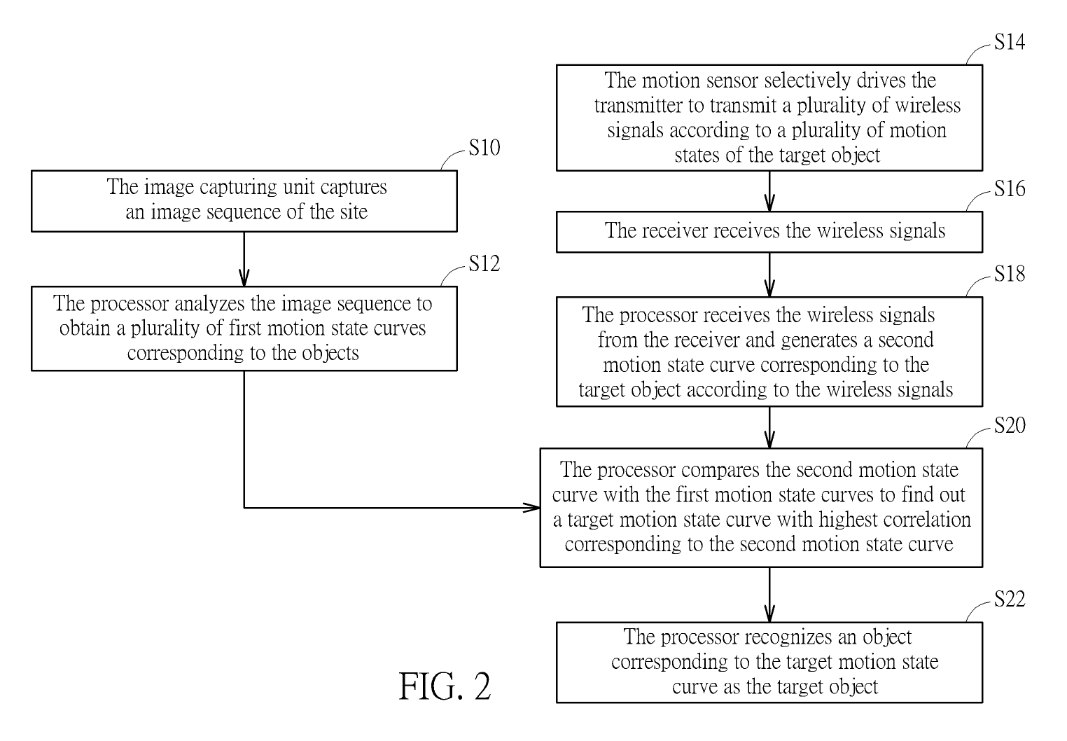

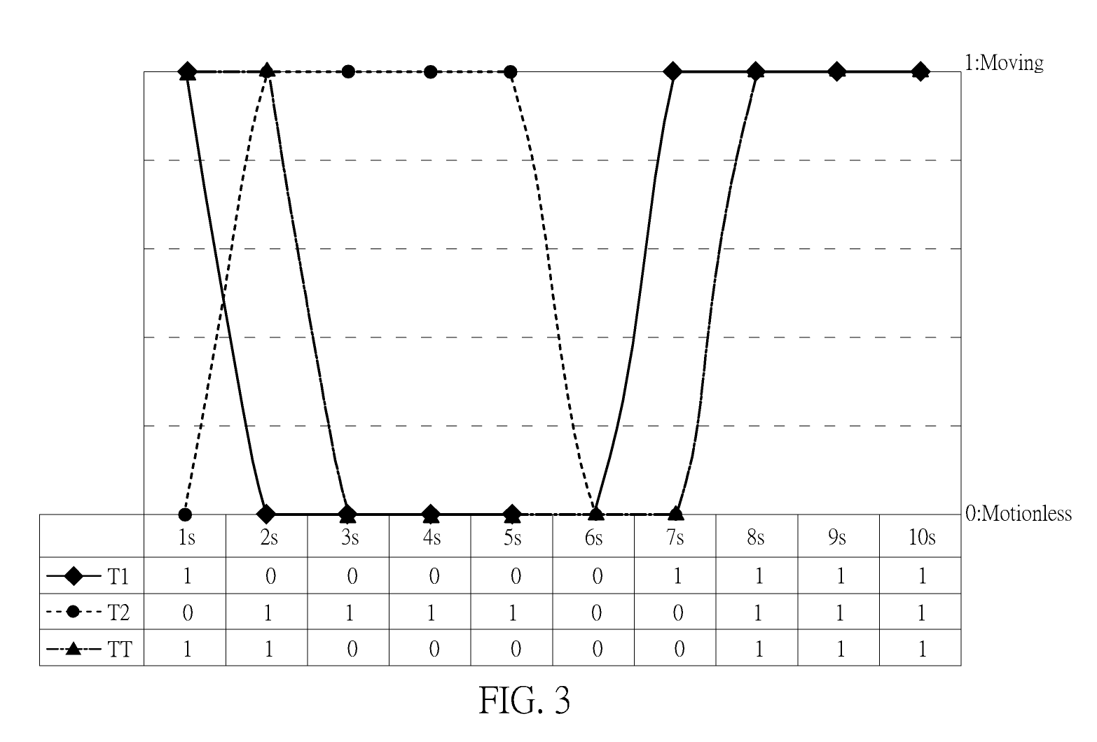

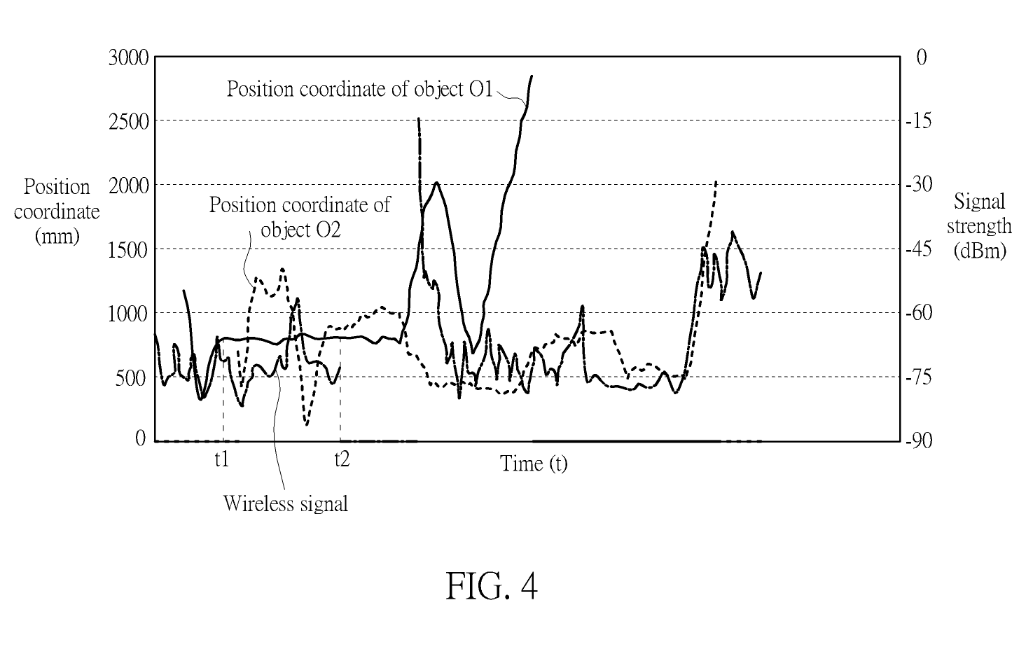

Referring to FIGS. 1 to 4, FIG. 1 is a schematic diagram illustrating an object recognition system 1 according to an embodiment of the invention, FIG. 2 is a flowchart illustrating an object recognition method according to an embodiment of the invention, FIG. 3 is schematic diagram illustrating motion state curves, and FIG. 4 is a schematic diagram illustrating position coordinate and signal strength. The object recognition method shown in FIG. 2 can be applied to the object recognition system 1 shown in FIG. 1.

As shown in FIG. 1, the object recognition system 1 comprises an image capturing unit 10, a motion sensing module 12, a receiver 14 and a processor 16. The image capturing unit 10 and the receiver 14 both are disposed in a site 3 and the processor 16 is coupled to the image capturing unit 10 and the receiver 14. In this embodiment, the invention may integrate the image capturing unit 10, the receiver 14 and the processor 16 in a camera (e.g. fish-eye camera) and dispose the camera at an appropriate position in the site 3. For example, the camera may be disposed on a ceiling of a retail store and capture images from top to bottom. However, in another embodiment, the invention may dispose the image capturing unit 10, the receiver 14 and the processor 16 separately. For example, the invention may dispose the processor 16 in a remote server (not shown) and the remote server may receive signals transmitted from the image capturing unit 10 and the receiver 14 to perform signal processing and calculating functions.

In practical applications, the image capturing unit 10 may be a charge-coupled device (CCD) sensor or a complementary metal-oxide semiconductor (CMOS) sensor, and the processor 16 maybe a processor or a controller with data processing/calculating functions.

The image capturing unit 10 is used for capturing an image sequence of the site 3. As shown in FIG. 1, a plurality of objects O1, O2 exist in the site 3, wherein the objects O1, O2 may be humans, animals or other objects. Accordingly, the objects O1, O2 will exist in the image sequence captured by the image capturing unit 10, wherein the objects O1, O2 comprise a target object O1. It should be noted that this embodiment uses two objects O1, O2 to depict the technical feature of the invention. However, the number of objects existing in the image sequence may be more than two.

The motion sensing module 12 is disposed on the target object O1. In this embodiment, the motion sensing module 12 comprises a transmitter 120 and a motion sensor 122, wherein the transmitter 120 is electrically connected to the motion sensor 122. The motion sensor 122 may selectively drive the transmitter 120 to transmit a plurality of wireless signals according to a plurality of motion states of the target object O1. The receiver 14 is used for receiving the wireless signals transmitted by the transmitter 120. In this embodiment, the receiver 14 and the transmitter 120 may receive and transmit wireless signals by WiFi, Bluetooth, infrared and so on.

When using the object recognition system 1 to perform the object recognition method, first of all, the image capturing unit 10 captures an image sequence of the site 3 (step S10 in FIG. 2). After receiving the image sequence, the processor 16 analyzes the image sequence to obtain a plurality of first motion state curves Tl, T2 corresponding to the objects O1, O2 (step S12 in FIG. 2), wherein the first motion state curve T1 corresponds to the object O1 and the first motion state curve T2 corresponds to the object O2, as shown in FIG. 3.

In this embodiment, the processor 16 may analyze whether the objects O1, O2 are situated at a moving state or a motionless state by image analysis technology, wherein the moving state may be labeled as 1 and the motionless state may be labeled as 0. Accordingly, the first motion state curves T1, T2 corresponding to the objects O1, O2 shown in FIG. 3 can be obtained. The time interval shown in FIG. 3 is set to be 1 second. However, the time interval maybe set according to practical applications, so the time interval is not limited to 1 second.

Furthermore, during the motion process of the objects O1, O2, the motion sensor 122 will selectively drive the transmitter 120 to transmit a plurality of wireless signals according to a plurality of motion states of the target object O1 (step S14 in FIG. 2). Then, the receiver 14 receives the wireless signals transmitted by the transmitter 120 (step S16 in FIG. 2). Then, the processor 16 receives the wireless signals from the receiver 14 and generates a second motion state curve TT corresponding to the target object O1 according to the wireless signals (step S18 in FIG. 2), as shown in FIG. 3)

In this embodiment, the motion sensor 122 may be a vibration sensor. The motion sensor 122 may switch off the transmitter 120 when the target object O1 is motionless. The motion sensor 122 may switch on the transmitter 120 and drive the transmitter 120 to transmit the wireless signals when the target object O1 is moving. Similarly, the moving state may be labeled as 1 and the motionless state may be labeled as 0. Accordingly, the processor 16 can generate the second motion state curve TT corresponding to the target object O1 according to the wireless signals received by the receiver 14.

In general, the vibration sensor may have a built-in timer. The vibration sensor may make the timer back to zero and switch on the transmitter 120 when sensing a motion. The vibration sensor may switch off the transmitter 120 if the vibration sensor does not sense any motion after a period of time counted by the timer. As shown in FIG. 4, the target object O1 is motionless at time point t1, so the motion sensor 122 may switch off the transmitter 120 at time point t2, i.e. the motion sensor 122 does not sense any motion from time point t1 to time point t2. When the target object O1 starts to move again, the motion sensor 122 will switch on the transmitter 120 and drive the transmitter 120 to transmit the wireless signals.

In another embodiment, the operating mode of the motion sensor 122 may be contrary to the aforesaid operating mode. For example, the motion sensor 122 may switch off the transmitter 120 when the target object O1 is moving and the motion sensor 122 may switch on the transmitter 120 and drive the transmitter 120 to transmit the wireless signals when the target object O1 is motionless.

After obtaining the first motion state curves T1, T2 and the second motion state curve TT shown in FIG. 3, the processor 16 compares the second motion state curve TT with the first motion state curves T1, T2 to find out a target motion state curve with highest correlation corresponding to the second motion state curve TT (step S20 in FIG. 2). In this embodiment, the comparison and analysis of the aforesaid correlation may be performed by Hamming distance algorithm, wherein the principle of Hamming distance algorithm is well known by one skilled in the art, so it will not be depicted in detail herein. It should be noted that the comparison and analysis of the aforesaid correlation may also be performed by covariance algorithm, Pearson's correlation coefficient algorithm and so on, wherein the covariance algorithm and the Pearson's correlation coefficient algorithm are well known by one skilled in the art, so they will not be depicted in detail herein.

Then, the processor 16 recognizes an object corresponding to the target motion state curve as the target object (step S22 in FIG. 2). For example, it is assumed that the invention uses the Hamming distance algorithm to perform the comparison and analysis of the aforesaid correlation. As the embodiment shown in FIG. 3, the sequence corresponding to the first motion state curve T1 is represented by 1000001111, the sequence corresponding to the first motion state curve T2 is represented by 0111100111, and the sequence corresponding to the second motion state curve TT is represented by 1100000111. Accordingly, the Hamming distance between the sequence corresponding to the first motion state curve T1 and the sequence corresponding to the second motion state curve TT is equal to 2, and the Hamming distance between the sequence corresponding to the first motion state curve T2 and the sequence corresponding to the second motion state curve TT is equal to 4. That is to say, the Hamming distance between the sequence corresponding to the first motion state curve T1 and the sequence corresponding to the second motion state curve TT is the smallest, so the correlation between the first motion state curve T1 and the second motion state curve TT is the highest . Therefore, the first motion state curve T1 is the aforesaid target motion state curve. Consequently, the processor 16 recognizes the object O1 corresponding to the first motion state curve T1 as the target object. Furthermore, the processor 16 may further determine whether the aforesaid correlation is larger than a threshold, i.e. the processor 16 may recognize an object with highest correlation larger than the threshold as the target object.

In the aforesaid embodiment, the image sequence comprises a plurality of objects and the processor 16 recognizes the target object from the objects. However, the invention is not limited to the aforesaid embodiment. In another embodiment, the image sequence may comprise one single object and the processor 16 may recognize whether the object in the image sequence is the target object according to the comparison and analysis of the aforesaid correlation between the motion state curves and the threshold.

The invention may take an identification card equipped with a vibration sensor and a Bluetooth transmitter to be the motion sensing module 12. In addition to the aforesaid vibration sensor, the motion sensor 122 may also be a G sensor or a gyro. At this time, the motion sensor 122 may drive the transmitter 120 to transmit the wireless signals any time according to the motion states of the target object O1. It should be noted that the principle of the G sensor or the gyro is well known by one skilled in the art, so it will not be depicted in detail herein. Furthermore, since the existing smart phone has the aforesaid motion sensor and a wireless communication module (e.g. Bluetooth) built therein, the invention may also take the smart phone to be the aforesaid motion sensing module 12, but is not so limited.

As mentioned in the above, the invention utilizes image analysis and motion sensor to recognize the target object carrying the motion sensing module from a plurality of objects. In practical applications, the invention may integrate the image capturing unit, the receiver and the processor in a camera, dispose the camera at an appropriate position in the site, and dispose the motion sensing module on an employee (i.e. the target object). After recognizing the employee carrying the motion sensing module by the aforesaid method, the invention can filter out the employee, so as to calculate accurate number of customers. Accordingly, the invention can use one single receiver along with image analysis to distinguish an employee and a customer from each other, such that the invention can reduce the cost of installation and maintenance effectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An object recognition system comprising:
an image capturing unit disposed in a site, the image capturing unit capturing an image sequence of the site, wherein at least one object exists in the image sequence and the at least one object comprises a target object;
a motion sensing module disposed on the target object, the motion sensing module comprising a transmitter and a motion sensor, the transmitter being electrically connected to the motion sensor, the motion sensor selectively driving the transmitter to transmit a plurality of wireless signals according to a plurality of motion states of the target object;
a receiver disposed in the site, the receiver receiving the wireless signals; and
a processor coupled to the image capturing unit and the receiver, the processor analyzing the image sequence to obtain at least one first motion state curve corresponding to the at least one object, the processor receiving the wireless signals from the receiver and generating a second motion state curve corresponding to the target object according to the wireless signals, the processor comparing the second motion state curve with the at least one first motion state curve and determining whether to recognize the at least one object corresponding to the at least one first motion state curve as the target object according to a correlation between the at least one first motion state curve and the second motion state curve.

2. The object recognition system of claim 1, wherein the motion sensor is a G sensor or a gyro and the motion sensor drives the transmitter to transmit the wireless signals any time according to the motion states of the target object.

3. The object recognition system of claim 1, wherein the motion sensor is a vibration sensor, the motion sensor switches off the transmitter when the target object is motionless, and the motion sensor switches on the transmitter and drives the transmitter to transmit the wireless signals when the target object is moving.

4. The object recognition system of claim 1, wherein the motion sensor is a vibration sensor, the motion sensor switches off the transmitter when the target object is moving, and the motion sensor switches on the transmitter and drives the transmitter to transmit the wireless signals when the target object is motionless.

5. The object recognition system of claim 1, wherein the image capturing unit, the receiver and the processor are integrated in a camera.

6. An object recognition method comprising steps of:
an image capturing unit capturing an image sequence of a site, wherein at least one object exists in the image sequence, the at least one object comprises a target object, a motion sensing module is disposed on the target object, the motion sensing module comprises a transmitter and a motion sensor, and the transmitter is electrically connected to the motion sensor;
the motion sensor selectively driving the transmitter to transmit a plurality of wireless signals according to a plurality of motion states of the target object;
a receiver receiving the wireless signals;
a processor analyzing the image sequence to obtain at least one first motion state curve corresponding to the at least one object;
the processor receiving the wireless signals from the receiver and generating a second motion state curve corresponding to the target object according to the wireless signals; and
the processor comparing the second motion state curve with the at least one first motion state curve and determining whether to recognize the at least one object corresponding to the at least one first motion state curve as the target object according to a correlation between the at least one first motion state curve and the second motion state curve.

7. The object recognition method of claim 6, wherein the motion sensor is a G sensor or a gyro and the object recognition method further comprises step of:
the motion sensor driving the transmitter to transmit the wireless signals any time according to the motion states of the target object.

8. The object recognition method of claim 6, wherein the motion sensor is a vibration sensor and the object recognition method further comprises step of:
the motion sensor switches off the transmitter when the target object is motionless; and
the motion sensor switches on the transmitter and drives the transmitter to transmit the wireless signals when the target object is moving.

9. The object recognition method of claim 6, wherein the motion sensor is a vibration sensor and the object recognition method further comprises step of:
the motion sensor switches off the transmitter when the target object is moving; and
the motion sensor switches on the transmitter and drives the transmitter to transmit the wireless signals when the target object is motionless.

10. The object recognition method of claim 6, wherein the image capturing unit, the receiver and the processor are integrated in a camera.
